(19) United States
(12) Patent Application Publication
(10) Pub. No.: US 2016/0191723 A1
(43) Pub. Date: Jun. 30, 2016

(54) Image Forming Apparatus with Direct Wireless Communication

(71) Applicant: KYOCERA Document Solutions Inc., Osaka (JP)

(72) Inventors: Tommy Yue, Concord, CA (US); Keisuke Fukushima, Concord, CA (US)

(21) Appl. No.: 14/585,124

(22) Filed: Dec. 29, 2014

(51) Int. Cl. H04N 1/00; H04W 12/06; H04N 1/44; H04W 76/02

(52) U.S. Cl. CPC H04N 1/00209; H04W 76/023; H04W 12/06; H04N 1/442; H04N 1/4486; H04N 1/00925; H04W 88/08

(57) ABSTRACT

The present disclosure is directed to an image forming apparatus. The image forming apparatus may connect to a local area network via at least one network interface. The image forming apparatus may also provide a network access point through which devices can wirelessly communicate. The image forming apparatus may further establish a wireless connection between the network access point and a terminal apparatus. Additionally, the image forming apparatus may receive, at the network access point, instructions to execute an operation of the image forming apparatus from the terminal apparatus. Upon disconnecting from the local area network, the image forming apparatus may maintain the established connection between the network access point and the terminal apparatus. The image forming apparatus may perform the operation specified by the received instructions upon determining that execution of the operation is permitted.

### BACKGROUND

Unless otherwise indicated herein, the materials described in this section are not prior art to the claims in this application and are not admitted to be prior art by inclusion in this section.

An image forming apparatus may be any peripheral that produces a human-readable representation of graphics and/or text onto a physical medium. Example image forming apparatuses include printers and multifunction peripherals (MFPs). An image forming apparatus may be utilized for various tasks such as printing, scanning, and faxing, as well as many other uses.

An image forming apparatus may be connected to a network and configured to receive operation instructions from devices communicating over the network. In some cases, a network may encounter an issue that requires the network to be restarted. While the network is being restarted, devices may be unable to communicate with the image forming apparatus, causing a substantial inconvenience to users and possibly a loss of data transmitted over the network.

Additionally, an encrypted network might require devices to have authentication credentials in order to connect to and communicate through the encrypted network. Sharing authentication credentials with guest devices (or other devices that do not usually connect to the encrypted network) to allow them to operate an image forming apparatus may introduce a risk to the security of the network and devices connected to the network.

### SUMMARY

The present application discloses embodiments that relate to an image forming apparatus that authorizes a user based on a biometric characteristic of the user. In one aspect, the present application describes a method. The method includes connecting to a local area network via at least one network interface. The method also includes providing, by the image forming apparatus, a network access point through which devices can wirelessly communicate. The method further includes establishing a wireless connection between the network access point and a terminal apparatus. In addition, the method includes receiving, at the network access point, instructions to execute an operation of the image forming apparatus from the terminal apparatus. Further, the method includes maintaining the established connection between the network access point and the terminal apparatus upon disconnecting from the local area network. The method also includes performing the operation specified by the received instructions upon determining that execution of the operation is permitted.

In another aspect, the present application describes an image forming apparatus. The image forming apparatus includes a network communication unit, at least one processor, and a storage device. The network communication unit may be configured to (i) communicate over one or more network interfaces and (ii) operate as a network access point through which devices can wirelessly communicate. The storage device may include instructions that, when executed by the at least one processor, cause the image forming apparatus to perform a set of steps. The steps include connecting to a local area network via at least one of the one or more network interfaces. The steps also include initiating operation of the network access point. The steps further include establishing a wireless connection between the network access point and a terminal apparatus. Additionally, the steps include receiving, at the network access point, instructions to execute an operation of the image forming apparatus from the terminal apparatus. Further, the steps include maintaining the established connection between the network access point and the terminal apparatus upon disconnected from the local area network. The steps also include performing the operation specified by the received instructions upon determining that execution of the operation is permitted.

In yet another aspect, the present disclosure describes a non-transitory computer-readable medium having instructions stored thereon that, upon execution by at least one processor, cause an image forming apparatus to perform a set of steps. The steps include connecting to a local area network via at least one network interface. The steps also include providing, by the image forming apparatus, a network access point through which devices can wirelessly communicate. The steps further include establishing a wireless connection between the network access point and a terminal apparatus. Additionally, the steps include receiving, at the network access point, instructions to execute an operation of the image forming apparatus from the terminal apparatus. Further, the steps include maintaining the established connection between the network access point and the terminal apparatus upon disconnecting from the local area network. The steps also include performing the operation specified by the received instructions upon determining that execution of the operation is permitted.

In another aspect, the present application describes a system. The system includes a means for connecting to a local area network via at least one network interface. The system also includes a means for providing, by the image forming apparatus, a network access point through which devices can wirelessly communicate. The system further includes a means for establishing a wireless connection between the network access point and a terminal apparatus. In addition, the system includes a means for receiving, at the network access point, instructions to execute an operation of the image forming apparatus from the terminal apparatus. Further, the system includes a means for maintaining the established connection between the network access point and the terminal apparatus upon disconnecting from the local area network. The system also includes a means for performing the operation specified by the received instructions upon determining that execution of the operation is permitted.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a schematic block diagram illustrating an image forming apparatus, according to an example embodiment.

FIG. 2 is a schematic block diagram illustrates an image forming apparatus, according to an example embodiment.

FIG. 3 is a schematic block diagram of a system, according to an example embodiment.

FIG. 4 is a flowchart illustrating a method, according to an example embodiment.

FIG. 5 is a flowchart illustrating a method, according to an example embodiment.

FIG. 6 is a schematic diagram illustrating example information displayed on a terminal apparatus, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments might include more or less of each element shown in a given Figure. Further, some of the illustrated elements may be combined or omitted. Yet further, an example embodiment may include elements that are not illustrated in the Figures.

### I. Overview

An example embodiment involves an image forming apparatus providing a persistent wireless access point through which devices can directly communicate with the image forming apparatus. This direct communication may be performed between a device and the image forming apparatus in the absence of a local area network. Thus, such an image forming apparatus may allow devices to execute operations, such as wireless printing, without requiring them to both be connected to the same local area network.

The image forming apparatus may also provide, in addition to the access point, a wired interface and/or a wireless interface through which devices may also communicate with the image forming apparatus over a local area network. In some instances, the local area network may need to be restarted, taken offline for servicing, or otherwise may encounter an issue that causes the network to be disabled. In these instances, the wireless access point may be maintained and provide a persistent interface for operating the printer when the local area network is offline.

Additionally, devices communicating directly through the wireless access point may be restricted to performing a subset of the image forming apparatus's operations. As one example, a network administrator may not want to permit guest devices access to a secure local area network. Guest devices may be authorized to communicate with the image forming apparatus directly through its wireless access point; however, one or more operations, such as transmitting a fax and/or scanning a document, may be prohibited when communicating over the wireless access point. This may prevent a guest device from possibly receiving a scan or transmitting a fax of private or confidential documents, and allow the guest device to wirelessly print documents stored, for example, on the guest device (although other operations may also be permitted for guest devices as well).

### II. Example Image Forming Apparatuses

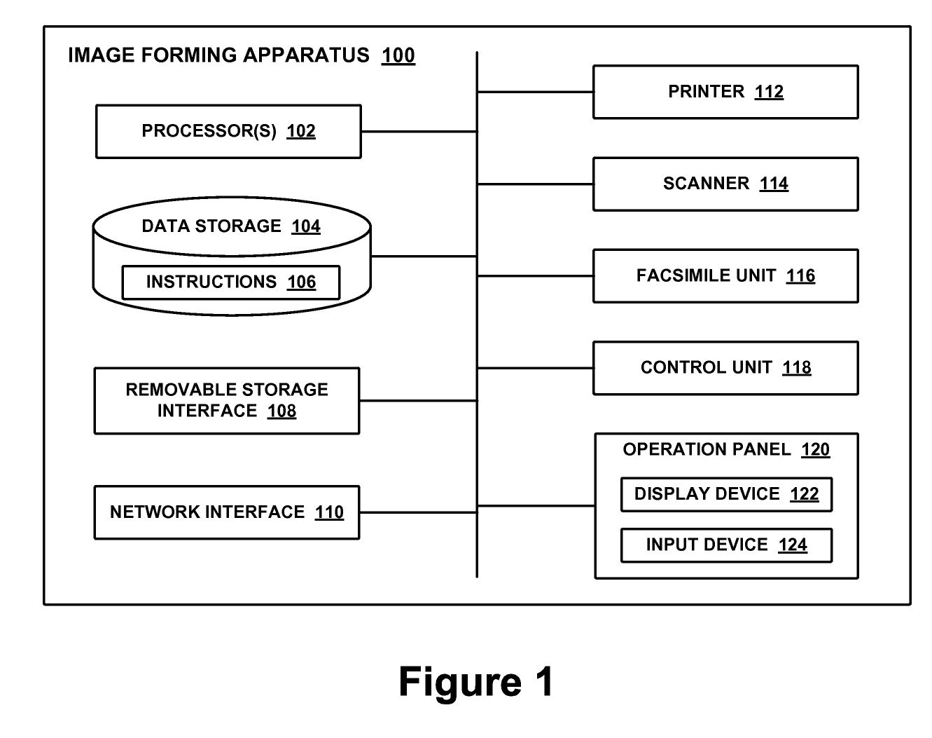

FIG. 1 is a schematic block diagram of illustrating an image forming apparatus 100, according to an example embodiment. The image forming apparatus 100 includes processor(s) 102, data storage 104 that has stored thereon instructions 106, a removable storage interface 108, a network interface 110, a printer 112, a scanner 114, a facsimile (FAX) unit 116, a control unit 118, and an operation panel 120 that includes a display device 122 and an input device 124. Each unit of image forming apparatus 100 may be connected to a bus, allowing the units to interact with each other. For example, the processor(s) 102 may request information stored on data storage 104.

The processor(s) 102 may include one or more processors capable of executing instructions, such as instructions 106, that cause the image forming apparatus 100 to perform various operations. The processor(s) 102 may include general-purpose central processing units (CPUs) and cache memory. The processor(s) 102 may also incorporate processing units for specific purposes, such as application-specific integrated circuits (ASICs) and field-programmable gate arrays (FPGAs). Other processors may also be included for executing operations particular to image forming apparatus 100.

The data storage 104 may store thereon instructions 106, which are executable by the processor(s) 102. The data storage 104 may also store information for various programs and applications, as well as data specific to the image forming apparatus 100. For example, the data storage 104 may include data for running an operating system (OS). In addition, the data storage 104 may store user data that includes various kinds of information about any number of users. The data storage 104 may include both volatile memory and non-volatile memory. Volatile memory may include random-access memory (RAM). Some examples of non-volatile memory include read-only memory (ROM), flash memory, electrically erasable programmable read only memory (EEPROM), digital tape, a hard disk drive (HDD), and a solid-state drive (SSD). The data storage 104 may include any combination of readable and/or writable volatile memories and/or non-volatile memories, along with other possible memory devices.

The removable storage interface 108 may allow for connection of external data storage, which may then be provided to the processor(s) 102 and/or the control unit 118 or copied into data storage 104. The removable storage interface 108 may include a number of connection ports, plugs, and/or slots that allow for a physical connection of an external storage device. Some example removable storage devices that may interface with image forming apparatus 100 via the removable storage interface 108 include USB flash drives, secure-digital (SD) cards (including various shaped and/or sized SD cards), compact discs (CDs), digital video discs (DVDs), and other memory cards or optical storage media.

The network interface 110 allows the image forming apparatus 100 to connect to other devices over a network. The network interface 110 may connect to a local-area network (LAN) and/or a wide-area network (WAN), such as the Internet. The network interface may include an interface for a wired connection (e.g. Ethernet) and/or wireless connection (e.g. Wi-Fi) to a network. The network interface 110 may also communicate over other wireless protocols, such as Bluetooth, radio-frequency identification (RFID), near field communication (NFC), 3G cellular communication such as CDMA, EVDO, GSM/GPRS, or 4G cellular communication, such as WiMAX or LTE, among other wireless protocols. Additionally, the network interface 110 may communicate over a telephone landline. Any combination of wired and/or wireless network interfaces and protocols may be included in network interface 110.

The printer 112 may be any device or peripheral capable of producing persistent human-readable images and/or text on a printing medium, such as paper. The printer 112 may receive print data from other units of image forming apparatus 100 representing images and/or text for printing. The printer 112 may employ a variety of technologies, such ink-based printing, toner-based printing, and thermal printing, among other technologies. An assortment of mechanical and/or electro-mechanical devices may make up the printer 112 to facilitate the transportation of printing media and the transferring of images and/or text onto the printing media. For example, the printer 112 may include trays for the storage and staging of printing media and rollers for conveying the printing media through the printer 112. The printer 112 may also include ink heads for dispensing ink onto a printing medium, photosensitive drums onto which lasers are shone to charge the drums and attract toner that is transferred onto a printing medium, and/or a thermal head for heating certain areas of a printing medium to generate images and/or text. Other devices may also be incorporated within printer 112.

The scanner 114 may be any device that can scan a document, image, or other object (which may collectively be referred to as “scanning medium” hereinafter) and produce a digital image representative of that scanning medium. The scanner 114 may emit light (e.g. via LEDs) onto the scanning medium and sense the light reflecting off the scanning medium (e.g. via a charge coupled device (CCD) line sensor or a complementary metal oxide semiconductor (CMOS) line sensor). In some implementations, the scanner 114 includes a platen glass onto which a document may be placed to be scanned. In addition, the scanner 114 may perform post-processing on the scanned image, such as rotation, compression of the data, and/or optical character recognition (OCR), among other post-processing operations.

The facsimile unit 116 may scan a document and/or images (which may be collectively referred to as “printed material” hereinafter) and transmit the scanned printed material over a telephone line (i.e. fax the scanned printed material). The facsimile unit 116 may fax the scanned printed material via the network interface 110. The facsimile unit 116 may also receive a fax transmission and communicate the received data to the printer 112 for printing. In some implementations, the facsimile unit 116 includes buttons for configuring the facsimile unit 116 and dialing a phone number and a display for displaying the status of the fax transmission, among other things.

The control unit 118 may control various electrical and/or mechanical components of the image forming apparatus 100. For example, the control unit 118 may operate one or more paper sheet feeders, conveyors, rollers, and other mechanical devices for transporting paper through the printer 112. The control unit 118 may also include device drivers that facilitate network communication, electronic displays, and the reading of information from various sensors or readers coupled to the image forming apparatus 100. In some implementations, the control unit 118 is a software application or program that interfaces the processor(s) 102 with the various units of the image forming apparatus 100.

The operation panel 120 includes a display device 122 and an input device 124 for facilitating human interaction with the image forming apparatus 100. The display device 122 may be any electronic video display, such as a liquid-crystal display (LCD). The input device 124 may include any combination of devices that allow users to input information into the operation panel 120, such as buttons, a keyboard, switches, and/or dials. In addition, the input device 124 may include a touch-screen digitizer overlaid onto the display device 122 that can sense touch and interact with the display device 112.

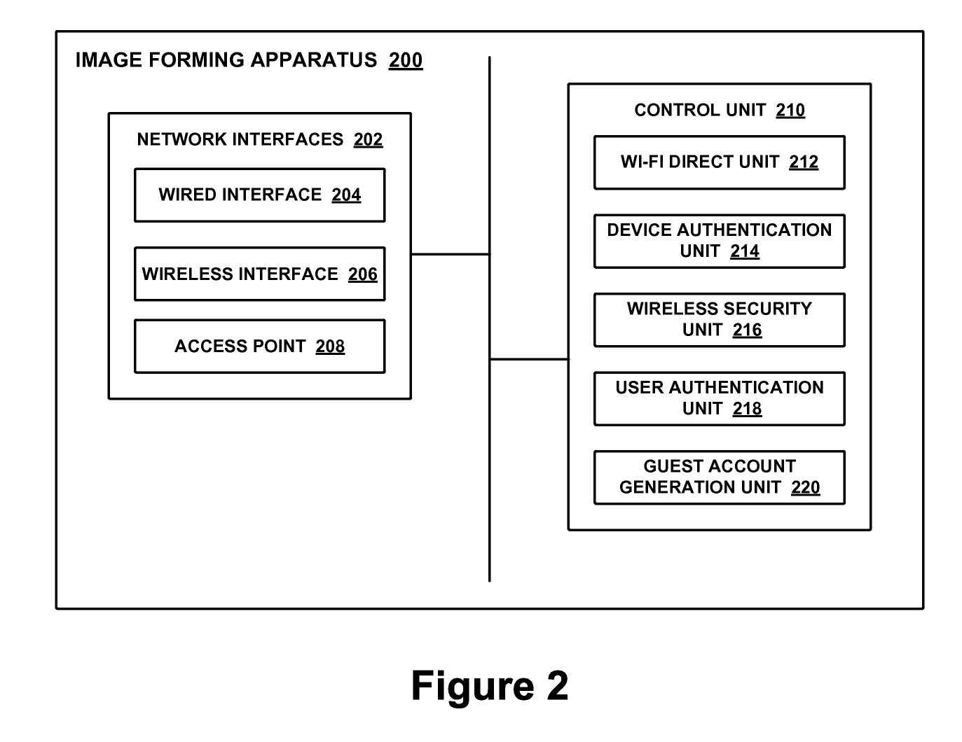

FIG. 2 is a schematic block diagram illustrating an image forming apparatus 200, according to an example embodiment. Image forming apparatus 200 may include any combination of the units of image forming apparatus 100. Additionally, image forming apparatus 200 includes network interfaces 202 and a control unit 210. The network interfaces 202 may include a wired interface 204, a wireless interface 206, and an access point 208. The control unit 210 may include a Wi-Fi direct unit 212, a device authentication unit 214, a wireless security unit 216, a user authentication unit 218, and a guest account generation unit 220. Similarly to image forming apparatus 100, each unit of image forming apparatus 200 may be connected to a bus, allowing the units to interact and communicate with each other.

The wired interface 204 may include software and/or hardware for connecting the image forming apparatus 200 to a router or other networking device. The wired interface 204 may allow the image forming apparatus 200 to connect to a local area network. As one example, the image forming apparatus may be connected to a router via a cable that conforms to an Ethernet standard (e.g. a coaxial cable, a twisted pair cable, or a fiber optic cable). The wired interface 204 may also include a network interface card or another networking adapter that facilitates the transmission of information over the cabled connection. In some embodiments, the hardware of the wired interface 204 is separate from the wireless interface 206. The wired interface 204 may also include software and/or firmware that controls the hardware and facilitates wired communications. Data, such as print job information, maintenance commands, and scanned document information may be transmitted over the wired interface 204.

The wireless interface 206 may include software and/or hardware for connecting the image forming apparatus 200 to a router or other networking device wirelessly. The wireless interface 206 may also allow the image forming apparatus 200 to connect to a local area network over a wireless access point provided from, for example, a router. As one example, the image forming apparatus may be connected to a router over a particular frequency band (e.g. around 2.4 GHz) based on 802.11 standards set forth by the Institute of Electrical and Electronics Engineers (IEEE). Some example standards that may be utilized include 802.11a, 802.11b, 802.11g, 802.11g, 802.11n, and/or 802.11ac, among other possible 802.11 protocols. The wireless interface 206 may also include a network interface card or another networking adapter that facilitates the transmission of information over the wireless connection. In some embodiments, the hardware of wireless interface 206 is separate from the wired interface 204. In other embodiments, a single networking card incorporates the wired interface 204 and the wireless interface 206. The wireless interface 206 may also include software and/or firmware that controls the hardware and facilitates wireless communications. Data, such as print job information, maintenance commands, and scanned document information may be transmitted over the wired interface 206.

The access point 208 may include software and/or hardware for providing a wireless access point through which devices can connect and communicate with image forming apparatus 200. The access point 208 may, in some instances, be implemented as an embedded software access point (which may be referred to herein as a “Soft AP”). A Soft AP may utilize the hardware of wireless interface 206 to provide access point 208. Such an implementation may also be referred to herein as “Wi-Fi Direct.” In some embodiments, the access point 208 may be implemented using a standalone network interface card or other networking adapter that is separate from the hardware of wired interface 204 and wireless interface 206. The access point 208 may also include software and/or firmware that controls the hardware and facilitates wireless communications. Data, such as print job information, maintenance commands, and scanned document information may be transmitted over the access point 208.

In some instances, software or other units of image forming apparatus 200 may control aspects of the access point's operation. In some embodiments, the access point 208 may provide an encrypted network connection (e.g. Wired Equivalent Privacy (WEP) encryption or Wi-Fi Protected Access (WPA or WPA2) encryption). The encryption settings may be modified by various units of the image forming apparatus 200. Additionally, the access point 208 may be enabled and disabled during operation of the image forming apparatus 200. Various units of image forming apparatus 200 may enable or disable the access point 208 based on certain conditions. “Enabling” the access point 208 may involve powering up the hardware of access point 208, making the access point 208 visible (e.g. enabling service set identification (SSID) broadcasting), or otherwise initiating the operation of access point 208. “Disabling” the access point 208 may involve powering down the hardware of access point 208, making the access point 208 hidden (e.g. enabling a “stealth” SSID mode), or otherwise terminating the operation of access point 208.

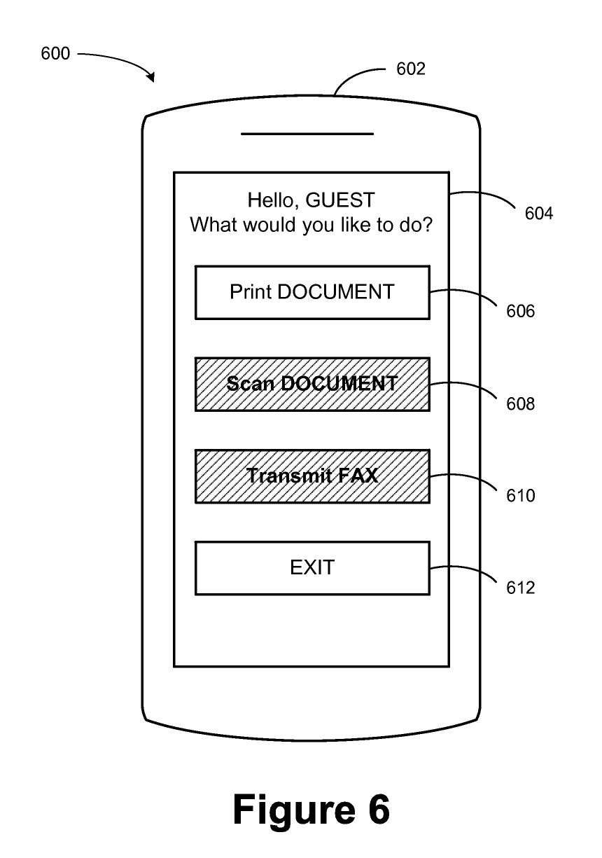

The access point 208 may receive data from external devices and/or transmit data to external devices. A device connected over access point 208 may send commands and/or other data to the image forming apparatus 200. For example, a device may send a print job including, for example, a command to execute printing, settings for the print job, and the document data to be printed over access point 208. The image forming apparatus 200 may also send information to devices connected over access point 208. For example, the image forming apparatus may transmit operation information to a device over access point 208 that enables the device to act as an operation panel. This may include command information, user interface (UI) information, and other information particular to the image forming apparatus 200. An example of a device displaying information received over access point 208 from image forming apparatus 200 is depicted in FIG. 6.

Note that “Wi-Fi Direct” may be used herein for explanatory purposes to refer to direct wireless communication. Other direct device-to-device wireless communication standards or protocols may also be used. Other example direct wireless communication techniques include Bluetooth, Near Field Communication (NFC), ZigBee, or other IEEE standards outside of the 802.11 protocols.

The Wi-Fi Direct unit 212 may include software and/or firmware used to control the access point 208 and, in some embodiments, wireless interface 206. The Wi-Fi Direct unit 212 may control aspects of the access point 208 described above. For example, the Wi-Fi Direct unit 212 may enable or disable the access point 208, control the encryption settings of access point 208, or otherwise modify the operation of access point 208.

The Wi-Fi Direct unit 212 may interface with a hardware button on the image forming apparatus or a software button provided, for instance, on operation panel 120 (e.g. via input device 124). When the button is depressed, the Wi-Fi Direct unit 212 may change the state of the image forming apparatus 200 to temporarily permit the establishment of a connection with a new device. This may involve transmitting network information (e.g. information about the protocol and the access point's SSID) and data indicating that the access point 208 is ready to receive new connection requests. In some embodiments, however, this indication may not be transmitted, but rather is just a change in the state of the access point 208 that is not publically broadcast. This state of allowing connection of new devices may only be available for a predetermined length of time after depression of the button (e.g. 30 seconds to 5 minutes, among other lengths of time).

During this temporary state, a device may transmit a request to connect to the image forming apparatus 200 via access point 208. The Wi-Fi Direct unit 212 may facilitate establishing this connection between the image forming apparatus and the device. Establishing the connection may involve the Wi-Fi Direct unit 212 controlling the access point 208 or wireless interface 206 to transmit network security credentials to the device. In some cases, however, no network security credentials are transmitted; this may be the case when the access point 208 provides a non-encrypted wireless connection (e.g. when the access point 208 is normally hidden, or when the access point 208 only permits communication of certain MAC addresses or other unique device identifiers). In some embodiments, establishing the connection may involve the Wi-Fi Direct unit 212 receiving a unique device identifier from the device (e.g. a MAC address) and adding the unique device identifier to a list of registered device identifiers.

After the connection has been established between the access point 208 and the device, the Wi-Fi Direct unit 212 may change the state of the access point 208 back to normal operation. This may involve making the access point 208 hidden and/or no longer responsive to requests to connect from other devices.

In some embodiments, the Wi-Fi Direct unit 212 may temporarily generate a password or personal identification number (PIN) that is displayed, for example, on the image forming apparatus's operation panel 120. In such embodiments, entering this PIN into the external device would initiate establishing the connection over the access point 208 (instead of or in combination with the push-button technique described above). Other additional steps of ensuring that an external device is requesting to establish a connection over access point 208 may also be implemented by Wi-Fi Direct unit 212.

The device authentication unit 214 may include software used to determine whether devices attempting to connect through the access point 208 are permitted to do so. An external device may include a data identifier that identifies the device, such as a MAC address or serial number. The device authentication unit 214 may store one or more device identifiers corresponding to one or more registered devices. The registered devices may have, for example, previously established a wireless connection over access point 208 or is otherwise registered onto image forming apparatus 200. The device authentication unit 214 may either allow or prohibit a device from communicating over access point 208, depending upon whether or not the device is registered. In some embodiments, the access point 208 receives information from a device, and the device authentication unit 214 determines whether or not the image forming apparatus should execute the operations indicated by instructions received from the device.

A given device may be restricted to operate only a subset of the operations that the image forming apparatus 200 is capable of executing. For instance, certain devices may be prevented from executing wireless printing, scanning, and/or faxing. The image forming apparatus 200 may store information about the operations allowed and/or permitted from being executed by one or more registered devices.

The wireless security unit 216 may include software to facilitate the encryption and decryption of data from encrypted wireless communications with external devices. If the network connection provided by the access point 208 is encrypted, the wireless security unit 216 may decrypt data received from a device communicating over the access point 208. Once decrypted, the received data may then be interpreted and operations of the image forming apparatus 200 may, if permitted, be executed. When the image forming apparatus 200 transmits information to a device over access point 208, the wireless security unit 216 may encrypt that data prior to the transmission.

The user authentication unit 218 may include software used to determine whether a user of a device communicating over access point 208 is permitted to do so. Similarly to the device authentication unit 214, the user authentication unit 218 may store information pertaining to one or more registered users that are permitted to operate the image forming apparatus 200 over access point 208. In some instances, a device may transmit information about a certain user over access point 208, and the user authentication unit 218 may compare the user information of registered users to determine whether to permit or prohibit execution of operations of the image forming apparatus 200. The registered user information may be referred to herein as a “user record.” A given user record may include various information associated with the user, such as a username, a password, one or more devices associated with that user, and information about the user's activity. Various metrics may be derived from this information, which may be used as a basis in determining whether a user may execute operations of the image forming apparatus 200.

A given user may be restricted to operate only a subset of the operations that the image forming apparatus 200 is capable of executing. For instance, certain users may be prevented from executing wireless printing, scanning, and/or faxing. The image forming apparatus 200 may store information about the operations allowed and/or permitted from being executed by one or more registered users.

In addition, various “levels” or “tiers” may be assigned to users that indicate a set of operations that users within that particular level or tier are permitted to execute. For instance, a particular level or tier may permit users within that level or tier from executing only wireless printing while prohibiting the remaining operations. As another example, a certain level or tier may be associated with maintenance or servicepersons that permit full operation of the image forming apparatus 200, along with possible additional operations associated with the maintenance and servicing of image forming apparatus 200.

The guest account generation unit 220 may include software for generating guest accounts that allow temporary access to one or more operations of the image forming apparatus 200 from an external device over access point 208. In some instances, a guest user may wish to wirelessly print (or perform other operations) at the image forming apparatus 200. The guest account generation unit 220 may generate a temporary guest account that allows the guest user on a guest device to execute one or more operations of the image forming apparatus 200. The guest account may be registered in a similar manner as described above; however, the guest account may also include an expiration date and time where, after the specified date and time, the guest account is prohibited from operating the image forming apparatus 200. Additional restrictions may be placed on the guest accounts generated by the guest account generation unit 220, such as printing page limit restrictions, scan location restrictions, and/or fax number transmission restrictions, among other restrictions. The guest account generation unit 220 may also assign a level or tier to the guest account.

A “unit” as referred to herein may refer to a device, component, module, or other combination of electrical and/or mechanical elements that accomplish a particular task. In some instances, a unit may refer to a physical device that performs certain activities, such as the facsimile unit 116. In other instances, a unit may refer to a software module that executes operations for a certain purpose, such as the guest account generation unit 220. Regardless of the combination of hardware and software components that make up a unit, it should be understood that units are operable to accomplish certain tasks, and may interact with other units through hardware and/or software interfaces.

The image forming apparatus 200 may include, in addition to the units depicted in FIG. 2, one or more components of image forming apparatus 100. Image forming apparatuses referred to herein may incorporate any combination of components from image forming apparatus 100 and/or image forming apparatus 200, among other possible components. For instance, an image forming apparatus may include a power supply that converts electrical power for use by various components. It should be understood that other additional components might also be included on a particular image forming apparatus.

### III. Example Systems

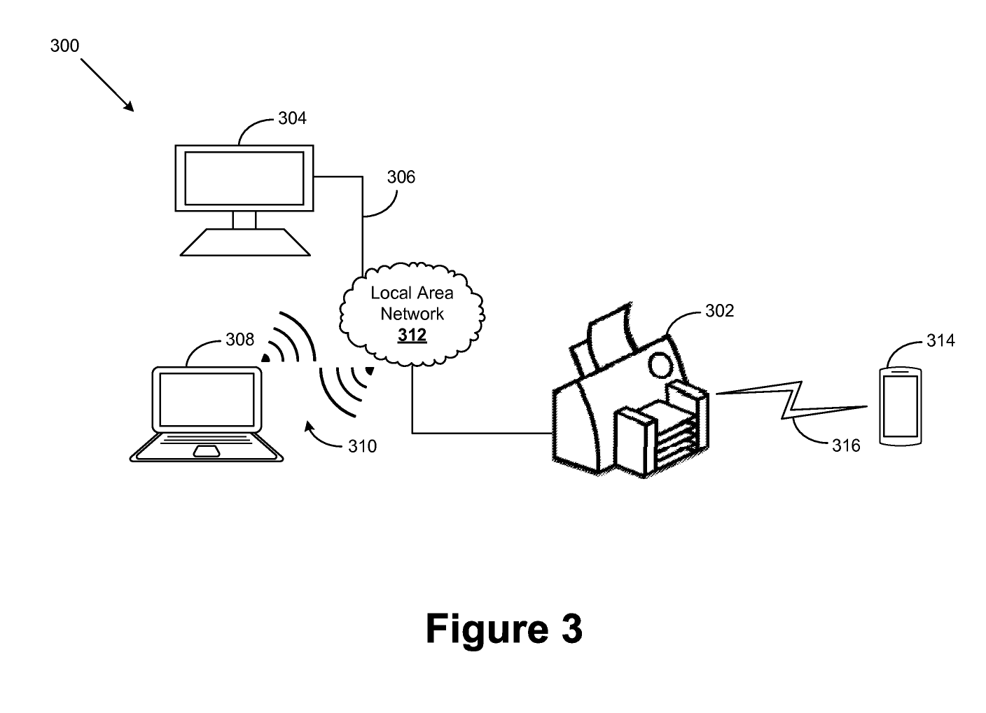

FIG. 3 is a schematic block diagram of a system 300, according to an example embodiment. The system 300 is an example system that includes an image forming apparatus 302, which may implement various units and methods described in the present application. The image forming apparatus 302 may be similar to image forming apparatus 200 and/or image forming apparatus 100, and may implement any of the units of image forming apparatus 200 and image forming apparatus 100.

The system 300 includes an image forming apparatus 302, a computer 304, a laptop 308, and a mobile device 314. The image forming apparatus 302 is connected to a local area network 312. Note that, while the connection is depicted as a line, the image forming apparatus 302 may connect to the local area network in a variety of ways, including over a wired connection or a wireless connection. The computer 304 is connected to the local area network 312 over a wired connection 306 (e.g. via the wired interface 204). The laptop 308 is connected to the local area network 312 over a wireless connection 310 (e.g. via the wireless interface 206) through the local area network. Note that communication over the wired connection 306 and the wireless connection 310 may be bidirectional; that is, the devices may both send and receive information over their respective connections. The image forming apparatus 302 is thus connected to the computer 304 and the laptop 308 through the local area network 312.

The image forming apparatus 302 also is connected to the mobile device 312 over a direct wireless connection 316. The direct wireless connection 316 may be established between the device 314 and the image forming apparatus 302 via a wireless access point, such as access point 208.

During operation, the image forming apparatus 302 relies on the local area network 312 to communicate with the computer 304 and the laptop 308. If, for example, the local area network 312 is restarted, disabled, disconnected, or otherwise taken offline, the communication between the image forming apparatus 302 and the computer 304 and laptop 308 is lost. However, regardless of the operating status of the local area network 312, the direct wireless connection 316 may be maintained between the image forming apparatus 302 and the mobile device 314.

Note that the computer 304, the laptop 308, and the mobile device 314 may be referred to herein as “terminal apparatuses.” The mobile device 314 may be referred to as the “first terminal apparatus,” and the computer 304 and/or the laptop 308 may be referred to as the “second terminal apparatus.” In some cases, the first terminal apparatus may be a terminal apparatus that communicates through an access point of an image forming apparatus (e.g. Wi-Fi Direct), whereas the second terminal apparatus may be a terminal apparatus that communicates through a network interface that is not the access point, such as via a wired or wireless interface.

It should be understood that the system 300 is an example system that is provided for explanatory purposes. Any number of mobile devices, computers, laptops, or other terminal apparatuses may be present and connected to the image forming apparatus 302 in a variety of ways.

### IV. Example Methods

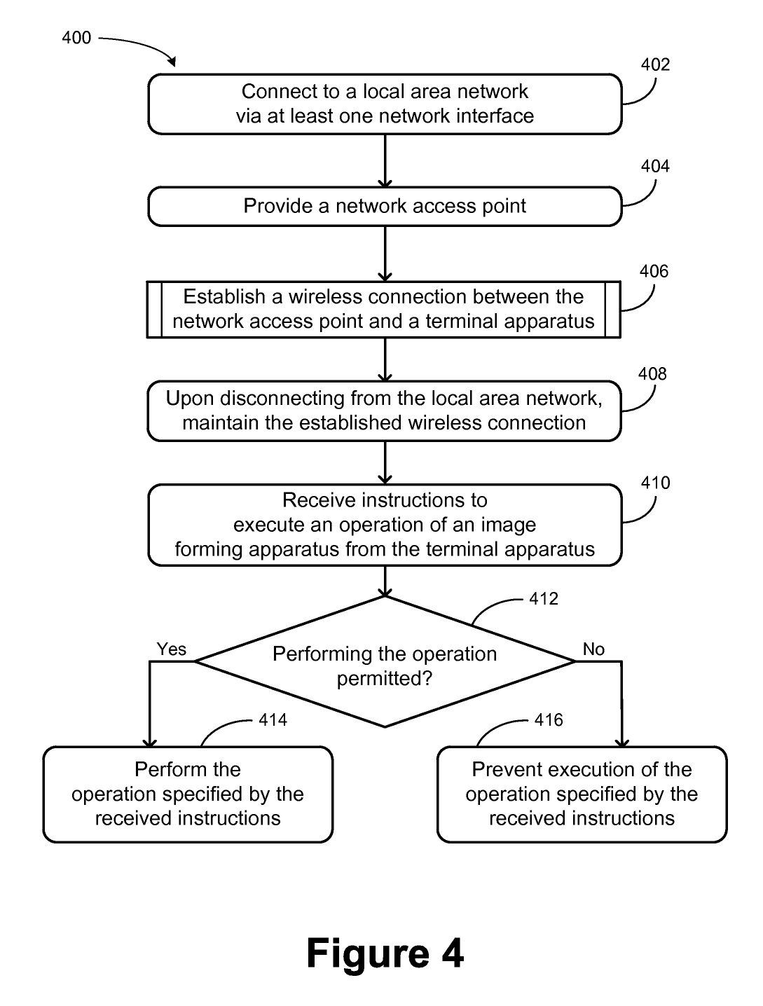

FIG. 4 is a flowchart illustrating a method 400, according to an example embodiment. More specifically, the method 400 depicts operations of an image forming apparatus that provides a wireless access point and performs permitted operations received from a terminal apparatus via the wireless access point. The method 400 may be performed on image forming apparatus 100 and/or image forming apparatus 200, among other possible image forming apparatuses or devices.

At step 402, the method 400 involves connecting to a local area network via at least one network interface. The local area network may include one or more routers or other networking devices that collectively form the local area network. The at least one network interface may include a wired connection (e.g. via wired interface 204) and/or a wireless connection (e.g. via wireless interface 206).

At step 404, the method 400 involves providing a network access point. The network access point may be similar to the access point 208 described above. Providing the network access point may involve changing the state of the access point 208 to accept requests to connect to the access point 208, broadcasting the network information of access point 208 (e.g. enabling SSID broadcasting), or otherwise making the access point 208 available to be connected to by other devices.

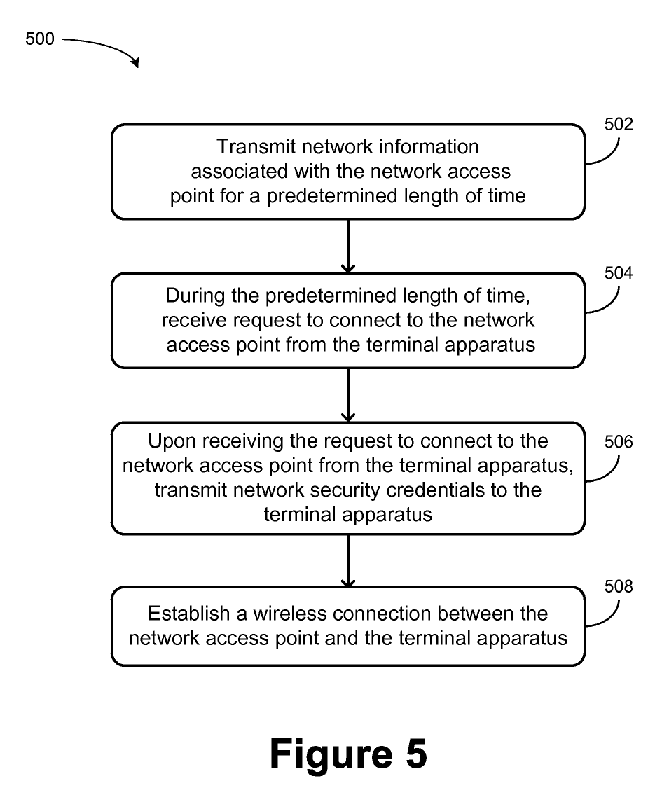

At step 406, the method 400 involves establishing a wireless connection between the network access point and a terminal apparatus. Step 406 may involve one or more steps or operations in order to establish the wireless connection. An example set of operations that collectively form step 406 is method 500 depicted in FIG. 5.

The wireless connection may be any direct wireless connection between the network access point and the terminal apparatus. In some embodiments, the wireless connection is a Wi-Fi Direct connection. For instance, step 406 may involve changing a state of an image forming apparatus to temporarily permit the establishment of new wireless connections. Then, an exchange of information between the image forming apparatus's network access point and the terminal apparatus may facilitate the establishment of the connection.

In some embodiments, establishing the connection may involve the Wi-Fi Direct unit 212 transmitting network information and other data indicating that the network access point is ready to receive new connection requests. This transmission of network information may be performed for a predetermined length of time, as described above. Then, the terminal apparatus may transmit a request to connect to the network access point. Upon receiving this request, the network access point may then pass information to the terminal apparatus for establishing the wireless connection, such as network security credentials, a token, or an indication that the device or user associated with the device is registered and permitted to communicate through the network access point. In the instances where network security credentials or a token is passed to the terminal apparatus, the terminal apparatus may then transmit a request that includes the network security credentials or token to the network access point to establish the connection.

At step 408, the method 400 involves maintaining the established wireless connection between the network access point and the terminal apparatus upon disconnecting from the local area network. In some instances, the image forming apparatus may disconnect from the local area network as a result of the local area network being deactivated, shut off, restarted, or otherwise disabled. For example, a network administrator may restart the local area network. In these instances, the wireless connection between the network access point and the terminal apparatus is maintained.

In some cases, the hardware and/or software of the image forming apparatus responsible for connecting to the local area network via a network interface may also need to be restarted or otherwise disabled. In some implementations, the network access point may preserve the wireless connection between the access point and the terminal apparatus despite the network interface being restarted or disabled. In other words, the access point may provide a persistent and direct wireless connection between the image forming apparatus and a terminal apparatus, regardless of whether the image forming apparatus is connected to a local area network.

At step 410, the method 400 involves receiving instructions to execute an operation of an image forming apparatus from the terminal apparatus. The instructions may include a particular operation of the image forming apparatus (e.g. printing, scanning, or faxing, among other operations), settings information (e.g. the manner in which to print, the scanning document file destination, or the phone number to which the fax is sent, among other information), and data associated with the operation (e.g. a document to be printed). In addition, the instructions may include flags, information about the terminal apparatus, or information about a particular user that is used to determine whether or not an operation may be executed at the image forming apparatus. Further, the instructions may include an authentication credential that indicates one or more operations permitted to be executed on the image forming apparatus.

At step 412, the method 400 involves determining whether performing the operation specified by the received instructions is permitted. The image forming apparatus may compare flags, information about the terminal apparatus, and/or information about a particular user to determine whether or not an operation is permitted.

As described above, the image forming apparatus may have stored thereon a list of registered devices and/or a list of registered users. Each registered device and/or registered user may be associated with a level or tier that corresponds to a set of operations that are permitted. For example, a certain device may be associated with a level that permits printing, but prohibits scanning and faxing. In some embodiments, each registered device and/or registered user may be individually associated with a set of permitted operations (i.e. the set of operations for a particular device or user may be set individually). The device authentication unit 214 may determine whether a particular device is permitted to perform a certain operation. The user authentication unit 218 may determine whether a particular user is permitted to perform a certain operation.

In other cases, the terminal apparatus may include software that limits the operations that may be performed. In such cases, the software on the terminal apparatus may include a flag or other piece of data indicating the level, tier, or other limitation of the terminal apparatus' operation that is transmitted along with the instructions to perform an operation. The image forming apparatus may then use the flag as a basis to permit or prohibit execution of the operation specified by the instructions.

In addition, the image forming apparatus may only permit certain operations for instructions received through the network access point. In embodiments where no device authentication or user authentication is performed, any terminal apparatus connecting through the network access point may be permitted to a certain set of operations. For example, a terminal apparatus may only be allowed to perform wireless printing, and may be prohibited from other operations such as scanning and faxing.

In some implementations, instructions may include an authentication credential that can be used to determine whether or not execution of a particular operation is permitted. The authentication credential may be data included with the instructions. A particular authentication credential may indicate that one or more operations of the image forming apparatus are permitted to be executed.

At step 414, the method 400 involves performing the operation specified by the received instructions if the performing operation is determined to be permitted in step 412. The image forming apparatus may perform the operation in accordance with the operation, settings, and data included with the instructions. In some instances, performing the operation may involve additional steps, such as retrieving documents to print from a server or storing a scanned document file onto a server.

At step 416, the method 400 involves preventing execution of the operation specified by the received instructions if the performing operation is determined to be prohibited in step 412. If the image forming apparatus—through the device authentication unit 214, the user authentication unit 218, or another means—determines that the operation is prohibited, the instructions may be discarded and the image forming apparatus either processes a subsequent operation or stops execution.

FIG. 5 is a flowchart illustrating a method 500, according to an example embodiment. More specifically, the method 500 depicts operations of establishing a direct wireless connection between a terminal apparatus and an image forming apparatus. The method 500 may be one example set of operations that collectively perform step 406 depicted in FIG. 4. The method 500 may be performed on image forming apparatus 100 and/or image forming apparatus 200, among other possible image forming apparatuses or devices.

At step 502, the method 500 involves transmitting network information associated with a network access point for a predetermined length of time. The network information, as described above, may include some information about the network (e.g. the network's SSID), along with an indication that the network access point is ready to accept requests for new connections. The predetermined length of time may provide a limited window of time through which devices may establish new connections with the network access point; some example predetermined lengths of time include 30 seconds to 10 minutes, among other lengths of time. The length of time may be increased or decreased, depending upon the particular implementation. Additionally, the transmission of the network information may stop at the point in time when a terminal apparatus establishes a connection with the network access point, which may occur prior to the end of the predetermined length of time. Thus, the predetermined length of time may be the maximum length of time to transmit network information.

At step 504, the method 500 involves receiving a request to connect to the network access point from the terminal apparatus during the predetermined length of time. The request may be a particular data message or other indication that the terminal apparatus is requesting to establish a new connection.

At step 506, the method 500 involves transmitting network security credentials to the terminal apparatus upon receiving the request to connect to the network access point from the terminal apparatus. As described above, this may include encryption information (e.g. the network's WEP or WPA password), a token that can be used to connect to the network access point, or another indication that the terminal apparatus is permitted to communicate over the network access point.

At step 508, the method 500 involves establishing a wireless connection between the network access point and the terminal apparatus. This may include the image forming apparatus receiving, at the network access point, the network security credentials or other information from the terminal apparatus necessary to initiate the wireless connection.

### IV. Example Implementations

FIG. 6 illustrates example information 600 displayed on a terminal apparatus 602, according to an example embodiment. The terminal apparatus includes a display device 604. In this example, the display device includes a touch screen that displays virtual buttons 606, 608, 610, and 612. Note that, while the terminal apparatus 602 depicted in FIG. 6 is a mobile device that includes a touch screen display device, other terminal apparatuses (e.g. computers, laptops, tablet devices, or other electronic devices) may also connect to a network access point of an image forming apparatus.

In the example depicted in FIG. 6, the terminal apparatus 602 has established a connection with a network access point of an image forming apparatus. The image forming apparatus then has proceeded to transmit information to the terminal apparatus 602 to act as an operation panel for the image forming apparatus. In this instance, the terminal apparatus 602 is associated with a GUEST account, which may have been generated by the guest account generation unit 220 and authenticated by the user authentication unit 218. In this example, the GUEST account is permitted to execute wireless printing, but is prohibited from performing other operations, such as scanning and faxing.

If a user presses button 606, instructions to execute printing of DOCUMENT may be transmitted to the image forming apparatus. DOCUMENT may be stored on the terminal apparatus 602, on a server, on a removable storage device connected to the image forming apparatus, or on the image forming apparatus itself.

If a user presses buttons 608 or 610, however, the image forming apparatus does not perform the scanning of DOCUMENT or transmission of FAX. These operations may be prohibited because the image forming apparatus has indicated to the terminal apparatus that GUEST is not allowed to execute those operations. Accordingly, buttons 608 and 610 may be grayed out, similarly to the buttons 608 and 610 depicted in FIG. 6, or otherwise displayed to indicate that those operations are not permitted.

If a user presses button 612, the terminal apparatus may close the direct wireless connection with the network access point and no longer act as the operation panel of the image forming apparatus.

It should be understood that the examples described with respect to FIG. 6 are merely example operations. Other operations may also be performed without departing from the scope of this application.

### V. Variations

Instructions to perform operations may be received over a direct wired connection or from a router connected to a local area network. In some embodiments, all operations of the image forming apparatus may be permitted to be executed when received over these network interfaces. Alternatively, all operations except for certain maintenance operations may be permitted over these network interfaces.

In some instances, the guest account generation unit 220 may set a time limit when creating a guest account. When this time limit expires, the image forming apparatus may no longer allow execution of operations from a device associated with that guest account.

In some cases, it may be desired to assist a maintenance person or another individual servicing the image forming apparatus by providing that person with additional maintenance operations that can be performed over the access point 208. For example, a maintenance person may wish to wirelessly print a test page, which may be available to that maintenance person but not other users of the image forming apparatus. In some cases, the maintenance person may be associated with a maintenance account that is authenticated by the user authentication unit 218. Other maintenance-assisting information may be provided to a maintenance person's terminal apparatus and displayed thereon to aid in the servicing of the image forming apparatus. For example, paper may be stuck at a certain location within the printer 112, and the image forming apparatus may display information to assist a person servicing the image forming apparatus that indicates the location of the paper jam.

### VI. Conclusion

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

1. A method comprising:
connecting to a local area network via at least one network interface of an image forming apparatus;
providing, by the image forming apparatus, a network access point through which devices can wirelessly communicate;
establishing a wireless connection between the network access point and a terminal apparatus;
receiving, at the network access point, instructions to execute an operation of the image forming apparatus from the terminal apparatus;
upon disconnecting, by the image forming apparatus, from the local area network, maintaining the established connection between the network access point and the terminal apparatus; and
performing the operation specified by the received instructions upon determining that execution of the operation is permitted.

2. The method of claim 1, wherein establishing the wireless connection between the network access point and the terminal apparatus comprises:
transmitting network information associated with the network access point for a predetermined length of time, wherein the network information indicates that the network access point is available to establish a new wireless connection;
during the predetermined length of time, receiving a request to connect to the network access point from the terminal apparatus;
upon receiving the request to connect to the network access point from the terminal apparatus, transmitting network security credentials to the terminal apparatus; and
wirelessly connecting the network access point to the terminal apparatus.

3. The method of claim 2, wherein transmitting the network information begins in response to depression of a button of the image forming apparatus.

4. The method of claim 1, further comprising:
terminating the wireless connection between the network access point and the terminal apparatus; and
disabling the network access point of the image forming apparatus.

5. The method of claim 1, wherein the image forming apparatus is configured to execute a plurality of operations, wherein one or more of the plurality of operations are restricted operations, and wherein the method further comprises:
preventing execution of the operation specified by the received instructions based on determining that the operation specified by the received instructions is among the restricted operations.

6. The method of claim 1, wherein the instructions include an authentication credential, and wherein the method further comprises:
determining that execution of the operation specified by the received instructions is permitted based on the received authentication credential.

7. The method of claim 6, further comprising:
generating the authentication credential that permits execution of one or more operations of the image forming apparatus,
wherein determining that execution of the operation specified by the received instructions is permitted is based on a match between the received authentication credential and the generated authentication credential.

8. The method of claim 1, wherein the image forming apparatus is configured to execute a plurality of operations, wherein one or more of the plurality of operations are restricted operations, and wherein the method further comprises:
enabling a maintenance mode on the image forming apparatus, wherein execution of the restricted operations is permitted while the maintenance mode is enabled.

9. The method of claim 1, wherein the network access point is configured to broadcast a network identification, and wherein the method further comprises:
upon establishing the wireless connection between the network access point and the terminal apparatus, disabling the broadcasting of the network identification.

10. The method of claim 1, wherein the terminal apparatus is a first terminal apparatus, and wherein the method further comprises:
receiving, the at least one network interface over the local area network, instructions to execute an operation of the image forming apparatus from a second terminal apparatus; and
performing the operation specified by the received instructions.

11. The method of claim 1, wherein the instructions to execute the operation are encrypted, and wherein the method further comprises:
decrypting the received instructions to execute the operation of the image forming apparatus.

12. The method of claim 1, wherein the terminal apparatus includes thereon an operation panel, and wherein the method further comprises:
providing operation information to the terminal apparatus, wherein the operation information includes one or more operations that can be executed on the image forming apparatus, and wherein the operation information can be displayed on the operation panel.

13. An image forming apparatus comprising:
a network communication unit configured to (i) communicate over one or more network interfaces and (ii) operate as a network access point through which devices can wirelessly communicate;
at least one processor; and
a storage device that includes instructions that, when executed by the at least one processor, cause the image forming apparatus to perform steps comprising:
connecting to a local area network via at least one of the one or more network interfaces;
initiating operation of the network access point;
establishing a wireless connection between the network access point and a terminal apparatus;
receiving, at the network access point, instructions to execute an operation of the image forming apparatus from the terminal apparatus;
upon disconnecting, by the image forming apparatus, from the local area network, maintaining the established connection between the network access point and the terminal apparatus; and
performing the operation specified by the received instructions upon determining that execution of the operation is permitted.

14. The image forming apparatus of claim 13, wherein establishing the wireless connection between the network access point and the terminal apparatus comprises:
transmitting network information associated with the network access point for a predetermined length of time, wherein the network information indicates that the network access point is available to establish a new wireless connection;
during the predetermined length of time, receiving a request to connect to the network access point from the terminal apparatus;
upon receiving the request to connect to the network access point from the terminal apparatus, transmitting network security credentials to the terminal apparatus; and
wirelessly connecting the network access point to the terminal apparatus.

15. The image forming apparatus of claim 13, wherein the image forming apparatus is configured to execute a plurality of operations, wherein one or more of the plurality of operations are restricted operations, and wherein the steps further comprise:
preventing execution of the operation specified by the received instructions based on determining that the operation specified by the received instructions is among the restricted operations.

16. The image forming apparatus of claim 13, wherein the instructions include an authentication credential, and wherein the steps further comprise:
determining that execution of the operation specified by the received instructions is permitted based on the received authentication credential.

17. A non-transitory computer-readable medium having instructions stored thereon that, upon execution by at least one processor, cause an image forming apparatus to perform steps comprising:
connecting to a local area network via at least one network interface of the image forming apparatus;
providing, by the image forming apparatus, a network access point through which devices can wirelessly communicate;
establishing a wireless connection between the network access point and a terminal apparatus;
receiving, at the network access point, instructions to execute an operation of the image forming apparatus from the terminal apparatus;
upon disconnecting, by the image forming apparatus, from the local area network, maintaining the established connection between the network access point and the terminal apparatus; and
performing the operation specified by the received instructions upon determining that execution of the operation is permitted.

18. The non-transitory computer-readable medium of claim 17, wherein establishing the wireless connection between the network access point and the terminal apparatus comprises:
transmitting network information associated with the network access point for a predetermined length of time, wherein the network information indicates that the network access point is available to establish a new wireless connection;
during the predetermined length of time, receiving a request to connect to the network access point from the terminal apparatus;
upon receiving the request to connect to the network access point from the terminal apparatus, transmitting network security credentials to the terminal apparatus; and
wirelessly connecting the network access point to the terminal apparatus.

19. The non-transitory computer-readable medium of claim 17, wherein the image forming apparatus is configured to execute a plurality of operations, wherein one or more of the plurality of operations are restricted operations, and wherein the steps further comprise:
preventing execution of the operation specified by the received instructions based on determining that the operation specified by the received instructions is among the restricted operations.

20. The non-transitory computer-readable medium of claim 17, wherein the instructions include an authentication credentials, and wherein the steps further comprise:
determining that execution of the operation specified by the received instructions is permitted based on the received authentication credential.
